(19) United States
(12) Patent Application Publication
(10) Pub. No.: US 2021/0156973 A1
(43) Pub. Date: May 27, 2021

(54) LIDAR RECEIVER WITH MULTIPLE DETECTION PATHS

(71) Applicant: Analog Devices, Inc., Norwood, MA (US)

(72) Inventors: Ronald A. Kapusta, Carlisle, MA (US); Miles R. Bennett, Stanford, CA (US); Lijun Gao, Shoreview, MN (US)

(21) Appl. No.: 16/697,793

(22) Filed: Nov. 27, 2019

(51) Int. Cl. G01S 7/4861; G01S 7/487

(52) U.S. Cl. CPC G01S 7/4861; G01S 7/4873; G01S 7/4876

(57) ABSTRACT

Techniques for using multiple detection paths in a light detection and ranging (LIDAR) receiver circuit. In general, the receiver circuit can perform more than one flow of filtering, detection, and estimation on the same return signal. One advantage of using multiple detection paths is the ability to extract different aspects of the return signal.

### FIELD OF THE DISCLOSURE

This document pertains generally, but not by way of limitation, to systems for providing light detection and ranging (LIDAR).

### BACKGROUND

Light detection and ranging (LIDAR) systems, such as automotive LIDAR systems, may operate by transmitting one or more pulses of light towards a target region. The one or more transmitted light pulses can illuminate a portion of the target region. A portion of the one or more transmitted light pulses can be reflected and/or scattered by an object in the illuminated portion of the target region and received by the LIDAR system. The LIDAR system can then measure a time difference between the transmitted and received light pulses, such as to determine a distance between the LIDAR system and the illuminated object. The distance can be determined according to the expression d=t*c/2, where d can represent a distance from the LIDAR system to the illuminated object, t can represent a round trip travel time, and c can represent a speed of light.

### SUMMARY OF THE DISCLOSURE

This disclosure describes, among other things, using multiple detection paths in a receiver circuit. In general, the receiver circuit can perform more than one flow of filtering, detection, and estimation on the same return signal. One advantage of using multiple detection paths is the ability to extract different aspects of the return signal. For example, a first detection path can use a low bandwidth filter to minimize noise and a low threshold to maximize detection probability. A second detection path can use a higher bandwidth filter in order to retain high frequency content and maximize precision of the distance estimate.

In some aspects, this disclosure is directed to a light detection and ranging (LIDAR) system comprising: a receiver circuit configured to receive a signal corresponding to light reflected from an object, the receiver circuit configured to split the signal between at least two signal processing paths, wherein each signal processing path is configured to perform at least one of filtering, transformation, or thresholding on the signal, and wherein the receiver circuit is configured to perform at least one of echo detection or distance estimation using a filtering, transformation, or thresholding output from more than one signal processing path.

In sonic aspects, this disclosure is directed to a method of operating a light detection and ranging (LIDAR) system having at least two signal processing paths, the method comprising: splitting a signal between the at least two signal processing paths, the signal corresponding to light reflected from an object; performing at least one of filtering, transformation, or thresholding on the signal; and performing at least one of echo detection or distance estimation using a filtering, transformation, or thresholding output from more than one signal processing path.

In some aspects, this disclosure is directed to a light detection and ranging (LIDAR) system comprising: a receiver circuit configured to receive a signal corresponding to light reflected from an object, the receiver circuit configured to split the signal between at least two signal processing paths; means for performing at least one of filtering, transformation, or thresholding on the signal; and means for performing at least one of echo detection or distance estimation using a filtering, transformation, or thresholding output from more than one signal processing path.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an example of a system architecture and corresponding signal flow, such as for implementing a LIDAR system in accordance with various techniques of this disclosure.

FIG. 2 illustrates another example of a system architecture and corresponding signal flow, such as for implementing a LIDAR system in accordance with various techniques of this disclosure.

FIG. 3 illustrates another example of a system architecture and corresponding signal flow, such as for implementing a LIDAR system in accordance with various techniques of this disclosure.

FIG. 4 illustrates another example of a system architecture and corresponding signal flow, such as for implementing a LIDAR system in accordance with various techniques of this disclosure.

### DETAILED DESCRIPTION

Light detection and ranging (LIDAR) systems generally include at least two functional blocks. The first block is the transmitter, which is responsible for generating and transmitting the illumination and all related functionality. The second block is the receiver, which is responsible for detecting the reflected illumination. Further functions, for example system control and signal processing can be split between the transmitter and receiver, contained fully within one of the two, or exist as separate blocks in the LIDAR system.

A pulsed LIDAR system can transmit a series of light pulses toward one or more objects and then measure the time-of-flight of any return signals resulting from those pulses. Echo detection is the process of resolving a LIDAR return signal into reflections from objects and other, non-interesting signals. Once an echo is detected, distance to the echo can be estimated.

Echo detection can include two aspects. First, the receiver circuit can perform some form of filtering or data transform to emphasize signal characteristics of interest while de-emphasizing other signals, such as noise. Second, the receiver circuit can perform thresholding (or discrimination) to discriminate actual reflections from non-reflections. The discrimination function can be extended to include a probabilistic output; for example, including a confidence parameter associated with a positively identified echo. The confidence parameter may be derived from the amplitude of the signal relative to the threshold level.

An example of a filter can be a “matched filter” in which a known pulse shape is convolved (or cross-correlated) with the return signal. If the shape of the transmitted pulse is known, that shape can be used as a filter, which can specifically emphasize the characteristics of interest. A matched filter can be a desirable filter to use to provide a high signal-to-noise ratio (SNR). In addition, filters such as low-pass or windowed integrals, can be used. Transforms can include slope detection, constant-fraction discrimination, and the like.

This disclosure describes, among other things, using multiple detection paths in a receiver circuit. In general, the receiver circuit can perform more than one flow of filtering, detection, and estimation on the same return signal. One advantage of using multiple detection paths is the ability to extract different aspects of the return signal. For example, a first detection path can use a low bandwidth filter to minimize noise and a low threshold to maximize detection probability. A second detection path can use a higher bandwidth filter in order to retain high frequency content and maximize precision of the distance estimate.

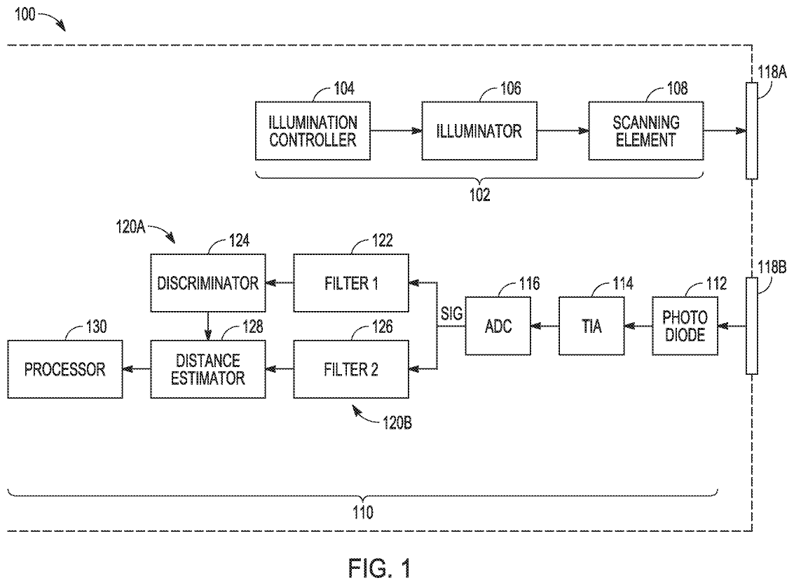

FIG. 1 illustrates an example of a system architecture 100 and corresponding signal flow, such as for implementing a LIDAR system in accordance with various techniques of this disclosure. The LIDAR system 100 can be a pulsed illumination LID AR system.

The LIDAR system 100 can include a transmitter circuit 102 having an illumination controller circuit 104, an illuminator circuit (or illuminator) 106, and an optional scanning element 108. The optional scanning element 108 can allow the system to scan through different regions-of-interest, for example.

The receiver circuit 110 can have a signal chain including a photodiode 112 coupled to a transimpedance amplifier (TIA) 114. The photodiode 112 can receive the light reflected from the object and can generate a current signal, for example. The TIA 114 can receive the current signal and output a voltage signal. The output of the TIA 114 can be digitized by an analog-to-digital (ADC) circuit 116.

In the example of FIG. 1, the illumination controller 104 (or control circuit) can be coupled to the illuminator circuit 106 and can control the illumination output of the illuminator circuit 106 to direct infrared pulses of light to a first window 118A and to a detector or detector array of the receiver circuit 110, such as including the photodiode 112.

During operation, the illumination controller 104 can provide instructions to the illuminator 106 and the optional scanning element 108, such as to cause the illuminator 106 to emit a light beam towards the scanning element 108 and to cause the scanning element 108 to direct the light beam out the first window 118A and towards a target region or object. In an example, the illuminator 106 can include a laser and the scanning element. The scanning element 108 can adjust an angle of the light beam based on the received instructions from the controller 104. The scanning element can be an electro-optic waveguide, a MEMS mirror, a mechanical mirror, an optical phased array, or any other optical scanning device.

Light scattered or reflected by a target or object in response to a light pulse from the illuminator 106 can be received through a second window 118B, such as through a receiver signal. For example, the received light can be detected by the photodiode 112, and a signal representative of the received light can be amplified by the TIA 114 and received by the ADC circuit 116.

The ADC circuit 116 can sample and store sequential samples of the signal representative of the received light. In a non-limiting example, the ADC circuit 116 can include a capacitor bank having a plurality of capacitors and the capacitor bank can receive and store charge representative of the samples. The ADC circuit 116 can then digitize the received samples and output the digital signal (“SIG”).

In accordance with this disclosure, the signal chain of the receiver circuit 110 can be configured to split the signal SIG between two or more signal processing paths 120A, 120B. In FIG. 1, although two signal processing paths 120A, 120B are depicted, the techniques of this disclosure are applicable to more than two signal processing paths.

The first signal processing path 120A can include a filter circuit 122 and an echo discriminator circuit 124. The filter circuit 122 can be configured to filter the received signal using one or more time domain coefficients and/or frequency domain coefficients applied to a mathematical operation, for example. The filter circuit 122 can filter the signal SIG and the discriminator circuit 124 can perform echo detection using the filtered output of the filter circuit 122. The discriminator circuit 124 can perform thresholding (discrimination) to discriminate actual reflections from non-reflections to determine whether an object was detected. If an intensity equals or exceeds a threshold of the discriminator circuit 124, then the discriminator circuit 124 can determine that a light pulse was received.

The second signal processing path 120B can include a filter circuit 126 and a distance estimator circuit 128. In some examples, the distance estimator circuit 128 can determine a peak of the return signal, which can indicate the location of the object. As seen in FIG. 1, the distance estimator circuit 128 of the signal processing path 120B can receive the output of the discriminator circuit 124 and thus use the echo detection of the signal processing path 120A.

In an example, the filter circuit 122 of the signal path 120A can be a lower bandwidth filter to maximize SNR and the filter circuit 126 of the signal path 120B can be a higher bandwidth filter to preserve as much timing information of the signal as possible for accurate distance estimation. In this manner, the signal path 120A can be used to detect whether an object is present and the signal path 120B can be used to estimate the distance to that object, for example.

As another example, the signal processing associated with detection versus distance estimation can be asymmetric. The signal path 120A could be implemented with a low power, low complexity filter 122 and/or discriminator 124. Conversely, the filter 126 and the discriminator 128 can be very accurate, complex, and high power to operate. However, the signal path 120B only needs to operate, and therefore dissipate power, when the signal path 120A has positively identified an echo. As a further extension, the signal path 120A can be used for pre-detection of echoes, e.g., noisy and inaccurate, whereas the signal path 120B can be responsible for both final discrimination of echoes and determination of distance using higher complexity, higher power, and highly accurate signal processing.

The output of the distance estimator circuit 128 can be applied to a processor 130. The processor circuit 130, such as a digital signal processor (DSP) or field programmable gate array (FPGA), can receive the digital output of the distance estimation circuit 128 and can perform further processing on the signal. The additional processing can include interpolation using the nominal distance estimate in combination with adjacent data in order to generate a higher resolution distance estimate. The additional processing can also include generation of a three-dimensional point cloud by combining the distance to the object with the spatial orientation of the scanning element. The additional processing can also include higher-level inference about the imaged environment, such as data clustering or object classification.

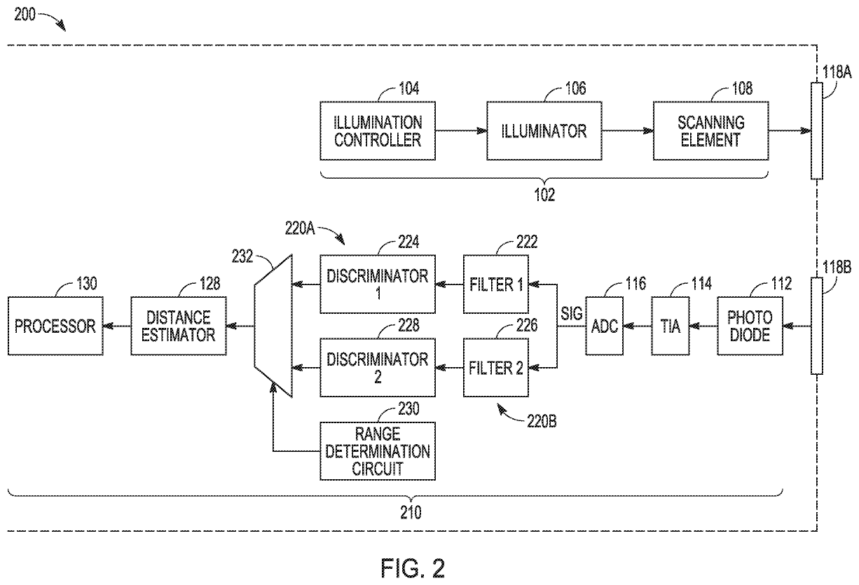

FIG. 2 illustrates another example of a system architecture 200 and corresponding signal flow, such as for implementing a LIDAR system in accordance with various techniques of this disclosure. The LIDAR system 200 can be a pulsed illumination LIDAR system. Some of the components of the LIDAR system 200 are similar to components of the LIDAR system 100 of FIG. 1 and like reference numbers are used to describe like components.

Similar to the LIDAR system 100 of FIG. 1, the LIDAR system 200 of FIG. 2 can include a receiver circuit 210 configured to split the signal SIG between two or more signal processing paths 220A, 220B. In FIG. 2, although two signal processing paths 220A, 220B are depicted, the techniques of this disclosure are applicable to more than two signal processing paths. Similar to the system 100 in FIG. 1, two filters 222, 226 having one or more different characteristics, e.g., frequency response, phase response, and the like, can be used in the two signal processing paths 220A, 220B. For example, the second filter 226 can have an amplitude or phase response versus frequency that is different than that of the first filter 222. In addition, two different discriminator circuits 224, 228 can be used, for example.

The receiver circuit 210 can include a range determination circuit 230 configured to determine a distance to the object. Using the range to the object determined by a range determination circuit 230 (or, in the time domain, the time that has elapsed since the pulse was transmitted), one of the signal processing paths 220A, 220B can be selected by a multiplexer 232 coupled to the outputs of the discriminators 224, 228. In other words, an output of the range determination circuit 230 can select one of the signal processing paths to be applied to the distance estimator circuit 128.

The first signal processing path 220A can include a first filter circuit 222 and a first discriminator circuit 224. The filter circuit 222 can filter the signal SIG and the first discriminator circuit 124 can perform thresholding (discrimination) on the output of the filter circuit 222 to discriminate actual reflections from non-reflections to determine whether an object was detected. If an intensity equals or exceeds a threshold of the discriminator circuit 224, then the discriminator circuit 224 can determine that a light pulse was received.

The second signal processing path 222A can include a second filter circuit 226, which can have different filter characteristics than that of the filter circuit 222, and a second discriminator circuit 228, which can have a different threshold than that of the discriminator circuit 224. The filter circuit 226 can filter the signal SIG and the second discriminator circuit 124 can perform thresholding (discrimination) on the output of the filter circuit 226 to discriminate actual reflections from non-reflections to determine whether an object was detected. If an intensity equals or exceeds a threshold of the discriminator circuit 226, then the discriminator circuit 226 can determine that a light pulse was received.

By way of non-limiting example, the signal processing path 220A can be used for objects determined by the range determination circuit 230 to be less than or equal to 15 meters and the signal processing path 220B can be used for objects determined by the range determination circuit 230 to be greater than 15 meters, In the signal processing path 220A, the filter circuit 222 and the discriminator circuit 224 can be optimized for close objects. The signal processing path 220B can use a different filter circuit and a different discriminator circuit optimized for objects that are farther away, where less accuracy is needed. Closer objects can result in larger return signals, so the discriminator circuit 224 of signal processing path 220A can have a higher threshold, for example, which can result in fewer false alarms.

As an example, starting at time 0 (when a pulse is launched by the transmitter circuit 102) through about 100 nanoseconds (for targets at a range of about 15 meters), the signal processing path 220A can be used to process return signals. For any return signals arriving after about 100 nanoseconds, the signal processing path 220B can be used for processing. More particularly, the range determination circuit 230 can output a control signal to the multiplexer 232, which is configured to select one of the signal processing paths 220A, 220B. In this manner, the receiver circuit 210, e.g., particularly the multiplexer 232, can perform echo detection using a thresholding output from signal processing paths 220A, 220B, e.g., from discriminator circuits 224, 228.

As seen in FIG. 2, the distance estimator circuit 128 can receive the output of the multiplexer 232 and thus use the echo detection in determining a distance to the object. The output of the distance estimator circuit 128 can be applied to a processor 130. The processor circuit 130, such as a digital signal processor (DSP) or field programmable gate array (FPGA), can receive the digital output of the distance estimation circuit 128 and can perform further processing on the signal.

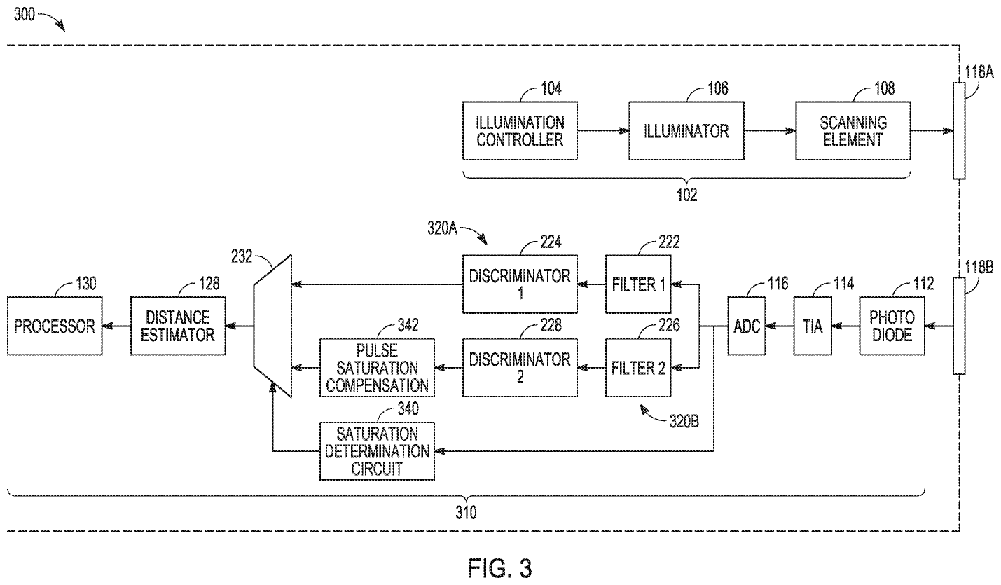

FIG. 3 illustrates another example of a system architecture 300 and corresponding signal flow, such as for implementing a LIDAR system in accordance with various techniques of this disclosure. The LIDAR system 300 can be a pulsed illumination LIDAR system. Some of the components of the LIDAR system 300 are similar to components of the LIDAR system 100 of FIG. 1 and the LIDAR system 200 of FIG. 2 and like reference numbers are used to describe like components.

Similar to the LIDAR systems of FIGS. 1 and 2, the LIDAR system 300 of FIG. 3 can include a receiver circuit 310 configured to split the signal SIG between two or more signal processing paths 320A, 320B. In FIG. 3, although two signal processing paths 320A, 320B are depicted, the techniques of this disclosure are applicable to more than two signal processing paths. Similar to the system 200 in FIG. 2, two different filters 222, 226 can be used in the two signal processing paths 220A, 220B. In addition, two different discriminator circuits 224, 228 can be used, for example.

As mentioned above, close objects can result in larger return signals, which can saturate the signal chain. For example, the return signal of a close object can generate more current than the photodiode 112 can output, or the return signal can generate a voltage swing greater than the full-scale value of the ADC 116. The present inventors have recognized that it can be desirable to use signal level information to select a signal processing path 320A, 320B. Using signal level information, a saturation determination circuit 340 can control a multiplexer 232 to select one of the signal processing paths 320A, 320B.

The saturation determination circuit 340 can be configured to determine a level of the signal. The saturation determination circuit 340 can have an output coupled to the multiplexer 232, and the output of the saturation determination circuit can select one of the signal processing paths 320A, 320B based on the level of the signal.

For example, the signal processing path 320A can be used for normal, unsaturated return signals. The filter circuit 222 can be a matched filter, for example, based on a nominal pulse shape, e.g., a Gaussian-shaped pulse. In other examples, alternative techniques for actively estimating the pulse shape can be used. The signal processing path 320B can be used for saturated return signals. The filter circuit 226 can be configured for a saturated pulse shape, e.g., clipped at the top rather than rounded at the top and widened in time. In some examples, the filter circuit 226 can be a matched filter having a pulse shape different from the pulse shape of the matched filter of filter circuit 222, e.g., a shape of a saturated pulse.

The saturation determination circuit 340 can be coupled to an output of the ADC 116. If the saturation determination circuit 340 determines that the output of the ADC 116 is at or near full-scale, then the saturation determination circuit 340 can output a control signal to the multiplexer 232 to select the signal processing path 320B to process a saturated signal. Otherwise, the saturation determination circuit 340 can output a control signal to the multiplexer 232 to select the signal processing path 320A for processing a normal, unsaturated signal. In this manner, the receiver circuit 310 can switch back and forth between the signal processing paths 320A, 320B depending on whether the output of the ADC 116 is clipped or not.

Using these techniques, the saturation determination circuit 340 can output a control signal to the multiplexer 232, which is configured to select one of the signal processing paths 320A, 320B. In this manner, the receiver circuit 310, e.g., particularly the multiplexer 232, can perform echo detection using a thresholding output from signal processing paths 320A, 320B, e.g., from discriminator circuits 224, 228.

As indicated above, the distance estimator circuit 128 can determine a peak of a return signal, which can indicate the location of the object. However, saturated return signals do not have well-defined peaks. As shown in FIG. 3, the signal processing path 320B, e.g., for a saturated signal, can include a pulse saturation compensation circuit 342 coupled to the output of the discriminator circuit 228. The pulse saturation compensation circuit 342 can receive the saturated signal, e.g., clipped signal, and perform a compensation on the signal by rounding the clipped peaks to a shape that would be expected of an unsaturated signal, which can allow the distance estimator circuit 128 to determine a peak had the signal not been saturated. In some examples, the pulse saturation compensation circuit 342 can also compensate the input pulse by altering its pulse width, as pulse width distortion is common in some types of photodiodes and TIAs when presented when saturated. In some examples, the pulse saturation compensation circuit 342 can be part of the distance estimator circuit 128.

The output of the multiplexer 232 can be applied to a processor 130. The processor circuit 130, such as a digital signal processor (DSP) or field programmable gate array (FPGA), can receive the digital output of the distance estimation circuit 128 and can perform further processing on the signal.

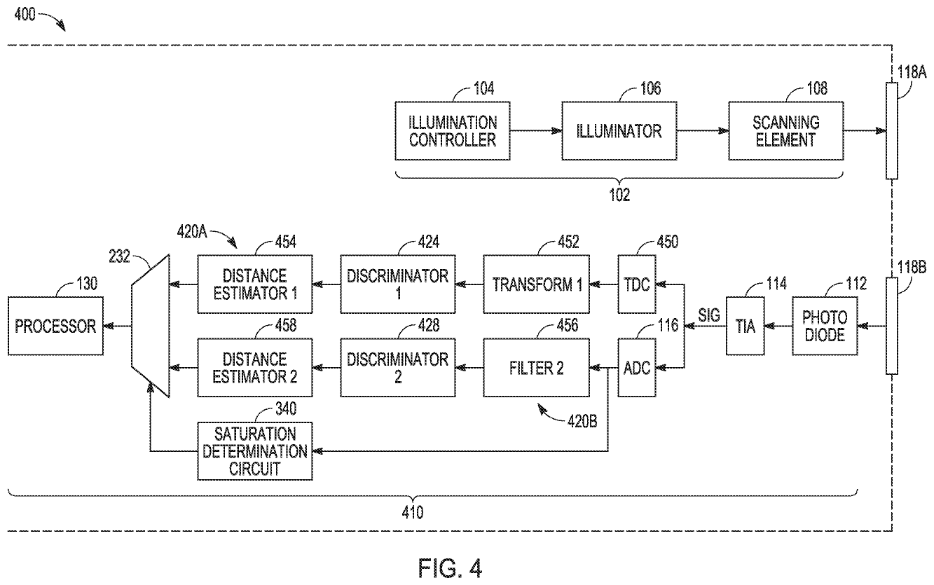

FIG. 4 illustrates another example of a system architecture 400 and corresponding signal flow, such as for implementing a LIDAR system in accordance with various techniques of this disclosure. The LIDAR system 400 can be a pulsed illumination LIDAR system. Some of the components of the LIDAR system 400 are similar to components of the LIDAR system 100 of FIG. 1, the LIDAR system 200 of FIG. 2, and the LIDAR system 300 of FIG. 3, and like reference numbers are used to describe like components.

Similar to the LIDAR systems of FIGS. 1-3, the LIDAR system 400 of FIG. 4 can include a receiver circuit 410 configured to split the signal SIG between two or more signal processing paths 420A, 420B. In FIG. 4, although two signal processing paths 420A, 420B are depicted, the techniques of this disclosure are applicable to more than two signal processing paths. Similar to the system 300 in FIG. 3, two different discriminator circuits 424, 428 can be used, for example.

In contrast to the LIDAR system of FIG. 3, the receiver circuit 410 of the LIDAR system 400 of FIG. 4 can split the signal SIG between two or more signal processing paths 420A, 420B prior to digitization. The receiver circuit 410 can include two different digitizer circuits, a time-to-digital converter (TDC) circuit 450 and analog-to-digital converter (ADC) 116 (e.g., amplitude-to-digital), that can each receive the signal SIG from the TIA 114.

Similar to FIG. 3 a saturation determination circuit 340 can control a multiplexer 232 to select one of the signal processing paths 420A, 420B using signal level information. For example, the signal processing path 420A with the TDC 450 can be used for saturated return signals. The TDC 450 can digitize time, not amplitude. The TDC 450 and can have a higher sampling rate than the ADC 116 and significantly less amplitude information about its input, which can make the TDC desirable for use with a saturated signal. The TDC can operate using an amplitude threshold that, when crossed by the signal, digitizes the time corresponding to the crossing. The digital output of the TDC 450 represents a time at which the crossing occurred and not an amplitude at a fixed point in time.

In some examples, the TDC 450 can be composed of several individual TDCs, each with a different threshold level. In this way, the output of the TDC 450 can be digitized values that represent the time at which its input reached multiple different amplitude levels.

In some other cases, the TDC 450 can be implemented as a low resolution, high sample rate ADC. For example, the ADC 116 can be 10-bit resolution and 1 GS/s sample rate and the TDC 450 can be implemented as an ADC with 3-bit resolution and 8 GS/s. The low resolution allows digital selection of several effective threshold levels, and the high sample rate can provide much better timing accuracy than could be achieved with the ADC 116 in the signal processing path 420B. Compared to the ADC 116, a low-resolution ADC-based implementation of the TDC 450 can be significantly lower power and lower complexity.

The digital output of the TDC 450 can be applied to the transform circuit 452. which can perform, for example, slope detection, and the like to emphasize signal characteristics of interest while de-emphasizing other signals, such as noise. The output of the transform circuit 452 can be applied to the discriminator circuit 424. In an example, the transform circuit 452 and the discriminator circuit 424 together can look for a rising edge followed by a falling edge at an appropriate later time. The output of the discriminator circuit 424 can be applied to the distance estimator circuit 454. A simple distance estimator might use the TDC output associated with the input signal rising edge as its distance estimate. Other, more complex schemes can also be used by the distance estimator circuit 454, such as using a combination of the TDC 450 outputs corresponding to both rising and falling edges, or a combination of the TDC 450 outputs corresponding to multiple amplitude levels. Such schemes can be used to mitigate errors in TDC-based distance estimators such as “walk error”, or input amplitude dependent distance errors.

The signal processing path 420B can be used for normal, unsaturated return signals. The filter circuit 456 can be a matched filter, for example, based on a nominal pulse shape, e.g., a Gaussian-shaped pulse, which can provide a good estimate of what the pulse should look like. In other embodiments, alternative techniques for actively estimating the pulse shape can be used. The discriminator circuit 428 can perform thresholding on the filtered signal. If an intensity equals or exceeds a threshold of the discriminator circuit 428, then the discriminator circuit 428 can determine that a light pulse was received.

The output of the discriminator circuit 428 can be applied to a distance estimator circuit 458. In some examples, the distance estimator circuit 458 can determine a peak of a return signal, which can indicate the location of the object. The distance estimator circuit 458 of the signal chain 420B can receive the output of the discriminator circuit 428 and thus use the echo detection of the signal path 420B.

The saturation determination circuit 340 can be coupled to an output of the ADC 116. If the saturation determination circuit 340 determines that the output of the ADC 116 is at full-scale, then the saturation determination circuit 340 can output a control circuit to the multiplexer 232 to select the signal processing path 420A to process a saturated signal. Otherwise, the saturation determination circuit 340 can output a control circuit to the multiplexer 232 to select the signal processing path 320B for processing a normal, unsaturated signal. In this manner, the receiver circuit 410 can switch back and forth between the signal processing paths 420A, 420B depending on whether the output of the ADC 116 is clipped or not.

Using these techniques, the saturation determination circuit 340 can output a control signal to the multiplexer 232, which is configured to select one of the signal processing paths 420A, 420B. In this manner, the receiver circuit410, e.g., particularly the multiplexer 232, can perform distance estimation using a thresholding output from signal processing paths 420A, 420B, e.g., from discriminator circuits 224, 228.

The output of the multiplexer 232 can be applied to a processor 130. The processor circuit 130, such as a digital signal processor (DSP) or field programmable gate array (FPGA), can receive the digital output of the distance estimation circuit 128 and can perform further processing on the signal.

### Notes

Each of the non-limiting aspects or examples described herein may stand on its own or may be combined in various permutations or combinations with one or more of the other examples.

The above detailed description includes references to the accompanying drawings, which form a part of the detailed description. The drawings show, by way of illustration, specific embodiments in which the invention may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact discs and digital video discs), magnetic cassettes, memory cards or sticks, random access memories (RAMS), read only memories (ROMs), and the like.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments may be combined with each other in various combinations or permutations. The scope of the invention should be determined with reference to the appended claims, along with the full scope of equivalents to which such claims are entitled.

The claimed invention is:

1. A light detection and ranging (LIDAR) system comprising:
a receiver circuit configured to receive a signal corresponding to light reflected from an object, the receiver circuit configured to split the signal between at least two signal processing paths,
wherein each signal processing path is configured to perform at least one of filtering, transformation, or thresholding on the signal, and
wherein the receiver circuit is configured to perform at least one of echo detection or distance estimation using a filtering, transformation, or thresholding output from more than one signal processing path.

2. The LIDAR system of claim 1, wherein the receiver circuit comprises a multiplexer coupled to the filtering, transformation, or thresholding output, and wherein the multiplexer is configured to select one of the signal processing paths.

3. The LIDAR system of claim 2, comprising:
a saturation determination circuit having an output coupled to the multiplexer, the saturation determination circuit configured to determine a level of the signal, wherein the output of the saturation determination circuit is configured to select one of the signal processing paths.

4. The LIDAR system of claim 1, wherein the signal chain is configured to perform echo detection using the filtering, transformation, or thresholding output of a first one of the signal processing paths, and wherein the signal chain is configured to perform distance estimation using the filtering, transformation, or thresholding output of a second one of the signal processing paths.

5. The LIDAR system of claim 4, wherein the signal chain configured to perform distance estimation using the filtering, transformation, or thresholding output of the second signal processing path also uses an echo detection output.

6. The LIDAR system of claim 2, comprising:
a range determination circuit having an output coupled to the multiplexer, the range determination circuit configured to determine a distance to the object, wherein an output of the range determination circuit selects one of the signal processing paths.

7. The LIDAR system of claim 1, wherein:
a first one of the signal processing paths includes a first filter; and
a second one of the signal processing paths includes a second filter having an amplitude or phase response versus frequency that is different than the first filter.

8. The LIDAR system of claim 7, wherein the first filter has a first bandwidth and the second filter has a second bandwidth, and wherein the second bandwidth is higher than the first bandwidth.

9. The LIDAR system of claim 1, wherein:
the first one of the signal processing paths includes a first discriminator having a first threshold; and
the second one of the signal processing paths includes a second discriminator having a second threshold different from the first threshold.

10. The LIDAR system of claim 1, wherein:
a first one of the signal processing paths includes a first matched filter defining a first pulse shape; and
a second one of the signal processing paths includes a second matched filter defining a second pulse shape different from the first shape.

11. The LIDAR system of claim 1, wherein:
a first one of the signal processing paths includes a time-to-digital converter; and
a second one of the signal processing paths includes an analog-to-digital converter,

12. The LIDAR system of claim 11, wherein:
the time-to-digital converter in the first signal processing path includes an analog-to-digital converter with higher sample rate and lower resolution than the analog-to-digital converter in the second signal processing path.

13. A method of operating a light detection and ranging (LIDAR) system having at least two signal processing paths, the method comprising:
splitting a signal between the at least two signal processing paths, the signal corresponding to light reflected from an object;
performing at least one of filtering, transformation, or thresholding on the signal; and
performing at least one of echo detection or distance estimation using a filtering, transformation, or thresholding output from more than one signal processing path.

14. The method of claim 13, further comprising;
selecting, by a multiplexer, one of the signal processing paths.

15. The method of claim 14, further comprising:
determining, by a saturation determination circuit, a level of the signal; and
selecting one of the signal processing paths using the determined level.

16. The method of claim 14, further comprising:
determining, by a range determination circuit, a distance to the object; and
selecting one of the signal processing paths using the determined distance.

17. The method of claim 13, further comprising:
in a first one of the signal processing paths, filtering the signal using a first matched filter defining a first pulse shape; and
in a second one of the signal processing paths, filtering the signal using a second matched filter defining a second pulse shape different from the first shape.

18. The method of claim 13, further comprising:
in a first one of the signal processing paths, performing time-to-digital conversion on the signal; and
in a second one of the signal processing paths, performing analog-to-digital conversion on the signal.

19. A light detection and ranging (LIDAR) system comprising:
a receiver circuit configured to receive a signal corresponding to light reflected from an object, the receiver circuit configured to split the signal between at least two signal processing paths;
means for performing at least one of filtering, transformation, or thresholding on the signal; and
means for performing at least one of echo detection or distance estimation using a filtering, transformation, or thresholding output from more than one signal processing path.

20. The LIDAR system of claim 19, wherein the receiver circuit comprises a multiplexer coupled to the the filtering, transformation, or thresholding, output, and wherein the multiplexer is configured to select one of the signal processing paths.
